(19) United States
(12) Patent Application Publication
(10) Pub. No.: US 2005/0233300 A1
(43) Pub. Date: Oct. 20, 2005

(54) Method for preserving sperm

(76) Inventor: Daniel Imoedemhe, London (GB)

Correspondence Address: TESTA, HURWITZ & THIBEAULT, LLP, HIGH STREET TOWER, 125 HIGH STREET, BOSTON, MA, 02110, US

(21) Appl. No.: 10/835,216

(22) Filed: Apr. 29, 2004

(30) Foreign Application Priority Data
Apr. 15, 2004 (CA) 2, 464, 550 CA

(51) Int. Cl. A01N 1/02

(52) U.S. Cl. 435/2

(57) ABSTRACT

A method for preserving spermatozoa (sperm) by air-drying. A semen sample is received and the sperm are separated from contaminants in the semen sample. The sperm may be separated from the semen sample by layering the semen sample onto a two-layer discontinuous percoll layer followed by centrifugation or by centrifuging the semen sample. The sperm concentrate is spread onto a sterile plate and allowed to air dry. The air-dried sperm may be stored at 0° C. to 8° C. The air-dried sperm may be recovered by adding a warm physiological solution to the air-dried sperm. The recovered sperm may be used for in vitro fertilisation or for intracystoplasmic sperm injection (ICSI).

### RELATED APPLICATION

This application claims priority to the corresponding Canadian application, filed Apr. 15, 2004.

### FIELD OF THE INVENTION

The present invention relates to a method for preserving sperm by means of air drying.

### BACKGROUND OF THE INVENTION

Sperm samples are required for artificial insemination techniques such as in vitro fertilisation. Sperm samples are currently preserved by freezing. This process typically involves the use of a cryoprotectant and a freezing machine. It involves a lengthy protocol and the samples are then stored in liquid nitrogen at −196° C. The actual process is time consuming and the storage tanks take up valuable space in laboratories. Whilst samples can be stored for an indefinite period of time, the means of storage is cumbersome and expensive. In addition, the transportation of samples is difficult as it requires special transport arrangements which increase the cost.

An experimental method of freeze drying sperm samples has also been utilised. This method requires the use of a freeze drying machine and optionally a cryoprotectant. Again, the method involves a long protocol requiring the use of liquid nitrogen and expensive specialised and bulky equipment.

The present methods of sperm preservation involve several factors which may adversely effect the quality of the recovered sperm. The cooling and thawing of the samples can cause cryo-injury and the rate of cooling and thawing can have implications for sperm survival. In addition, the sperm are exposed to osmotic shock and stresses from exposure to a cryoprotectant which may also have an effect on the viability of the sperm. In addition, the freezing of the sperm may induce sublethal damage that may be genetic.

The present method can also raise concerns for patients such as security, disease transmission and the potential for gamete mixing. There is a potential risk for transmission of diseases such as HIV, Hepatitis A and B, Herpes Simplex Virus and other viruses and/or bacteria between sperm samples stored together over long periods in the liquid nitrogen tanks. Therefore, mandatory screening of all sources of semen submitted for sperm freeze storage may be required. This would not only raise the cost of carrying out the procedure but also raise logistical problems as in the case of HIV a period of six (6) months may become mandatory to ensure that a particular source of sperm is free of the virus. This is the period required to enable detection of antibodies to the virus to be possible. A sperm sample source with recent exposure to the virus and carrying the virus in their system may not therefore be detected as positive for the HIV antibody.

Sperm samples may be permeated by liquid nitrogen through cracks in storage tubes and vials and leaks, particularly where seals are not properly formed. In addition, liquid nitrogen can be absorbed by the cryo-vials, up to 1 ml in some types of freeze-storage vials. These incidents may expose the common storage pool of liquid nitrogen to any organisms that may be present in such a defective storage tube or vials thus making it possible for other defective tubes and vials in the pool to be contaminated by the organism. Finally, inadvertent depletion of liquid nitrogen in the storage tanks for any reason may result in the loss of all samples stored in that tank with catastrophic implication for some sources of the sample of sperm

Therefore, there exists the need for a new method of preserving sperm samples that is inexpensive, easy to carry out and leads to samples which can be easily stored without the requirement of the cumbersome liquid nitrogen containers.

### SUMMARY OF THE INVENTION

This invention describes a method for preserving a semen sample comprising receiving a semen sample and allowing the semen sample to air dry. The spermatozoa may be separated from other contaminants present in the semen sample, either by centrifuging the semen sample to concentrate the spermatozoa, or by layering the semen sample onto a two layer discontinuous percoll layer followed by centrifugation. The sample may be liquefied before being spread on a sterile plate and air dried. The dried sample may be stored at 0° C. to 8° C.

The invention also described a method for preserving a semen sample by allowing the semen sample to air dry and recovering the sample from its dried state by adding a warm physiological solution, such as phosphate buffered saline, to the sample. Recovered samples may be used for in vitro fertilisation or may be used for intra-cytoplasmic sperm injection (ICSI).

### BRIEF DESCRIPTION OF THE DRAWINGS

These and other aspects of this invention will be readily apparent from the detailed description below and the appended drawings, which are meant to illustrate and not to limit the invention, and in which:

FIG. 1A is a photograph of air-dried sperm.

FIG. 1B is a photograph of air-dried and re-suspended sperm.

FIGS. 2A and 2B are photographs of the same air-dried sperm sample, after storage for 8-10 months at 0-8° C., under different lighting conditions.

FIGS. 3A, 3B, 3C, and 3D are photographs of re-suspended sperm after air-drying and storage for 8-10 months at 0° C. FIGS. 3A and 3B are photographs of the same sperm under different light conditions. FIGS. 3C and 3D are photographs of the same sperm under different light conditions.

FIGS. 4A and 4B are photographs of air-dried sperm after storage for 6-8 months at ambient temperature.

FIG. 5 is a photograph of an air-dried sperm, re-suspended after storage for 6-8 months at ambient temperature.

FIG. 6 is a photograph of an air-dried sperm after storage for 9 months at 8° C.

FIGS. 7A and 7B are photographs of human embryos derived from eggs fertilized by air-dried sperm. FIG. 7A is a photograph of a normal, 4-cell human embryo. FIG. 7B is a photograph of an early human blastocyst.

### DESCRIPTION OF THE PREFERRED EMBODIMENTS

The present invention provides a method for preserving a semen sample comprising allowing the sample to air dry.

The term “semen sample,” as used herein, means both semen samples and also epididymal aspirates.

In one preferred embodiment the sample is spread onto a sterile flat surface so that it forms a uniformly thin layer prior to drying. Preferably the sample is spread onto a sterile plate, more preferably a sterile glass plate, such as a glass slide. The sample is allowed to liquefy prior to being spread on the sterile glass slide and air dried.

The present invention provides a method which is both cheap and easy to carry out, without the need for specialized equipment. Therefore, it can be used even in remote areas or developing countries.

In one embodiment of the invention, the semen samples are assessed for the presence of spermatozoa, bacterial particles, white blood cells and other debris. When there are a large number of contaminants in the sample, the spermatozoa need to be isolated from the debris. Thus, in another embodiment the method of the present application further comprises separating the sperm from contaminants in the semen sample. This is preferably carried out by layering the semen sample onto a two layer discontinuous percoll layer followed by centrifugation. The spermatozoa collect in the two layer percoll interface separating them from the heavier particles which settle at the bottom of the tube. This is a well established standard procedure. The sperm concentrate is aspirated from the interface and is washed by standard methods by diluting the concentrate in a physiological solution. The sample is spun in a centrifuge to concentrate the spermatozoa in a pellet. The pellet is then re-suspended in a small volume of a physiological solution which can then be spread onto the sterile surface prior to being air dried. The reverse side of the sterile surface is preferably marked to localise the area in which the sample is spread. This allows the dried sample to be located, as the site of the spread and dried sample may appear transparent depending on the concentration of sperm in the initial sample.

The method of the present invention can be used in cases where there is a very low sperm count. In cases where the semen sample contains very few spermatozoa, and when the samples are epididymal aspirates, the spermatozoa need to be concentrated. Thus, in another preferred embodiment the method of the present invention further comprises centrifuging the semen sample to concentrate the spermatozoa. As described above, the pelleted cells are re-suspended in a small volume of a physiological solution which is then spread on the sterile surface prior to air drying.

The samples are allowed to dry under a gentle draft of air from a fan or the like. Adequate drying of the sample is obtained in 10 to 20 minutes if the sample has been properly spread. Once the samples are dry the slides can be loaded into an appropriate sterile holder and stored in a refrigerator at a temperature of between 0° C. to 8° C. Results indicate that spermatozoa with normal morphology can be recovered after 8-12 months storage and used for intracytoplasmic sperm injection (ICSI) into a human oocyte (egg) to assist fertilisation. Experiments have shown that prolonged storage of air dried samples at ambient (room) temperature causes structural damage to the spermatozoa as a result of excessive dehydration or desiccation, thereby making them unsuitable for use in intracytoplasmic sperm injection (ICSI).

As the samples are kept on glass slides, they can be easily stored in a refrigerator. Therefore, large numbers of samples can be stored individually, packed within one refrigerator, thus reducing the amount of space required to store a number samples. In addition, the samples can be transported more easily as they do not need to be kept frozen during transit.

The samples can be kept in individual sterile holders. As the samples are dry, the risk of cross contamination or disease transmission is greatly reduced.

In another aspect, the present invention provides a method for recovering viable sperm from an air dried sample comprising adding a warm physiological solution to said sample. A sterile pipette is used to add a large drop of warm physiological solution such as phosphate buffered saline or other physiological commercially available cell culture medium at 37° C. to the sample so that it covers the entire area on which the sample is spread. Care must be taken that the solution does not overflow the edges of the plate on which the sample is spread. After two minutes, the sample is gently stirred in a circular fashion to re-suspend the semen sample and optimise sample recovery. The sample is aspirated and placed in a sterile tube. The procedure is repeated with another drop of physiological solution to ensure complete sperm recovery. The test tube is left in an incubator at 37° C. for 15 to 20 minutes. If the sperm has been washed free of seminal fluid prior to the drying process, the re-suspended sperm can be recovered directly from the re-constituted sample for use for ICSI. If a neat semen sample is used for air drying, the re-suspended sperm sample can be washed to remove the seminal fluid prior to sperm recovery for use for ICSI into the egg.

In a further aspect, the present invention provides the use of a sperm recovered from an air dried semen sample for in vitro fertilisation. In particular, the sperm can be used for intracystoplasmic sperm injection (ICSI).

The methods of the present invention can be carried out using semen samples from any species, in particular mammals, preferably humans. This method allows a large number of samples to be stored in a smaller space. It can be used to store samples from animals with rare qualities for later use in the animal husbandry or breeding industry. Samples from rare animals, such as those threatened with extinction, can also be stored.

The invention will now be described in the non-limiting examples below with reference to the following figures:

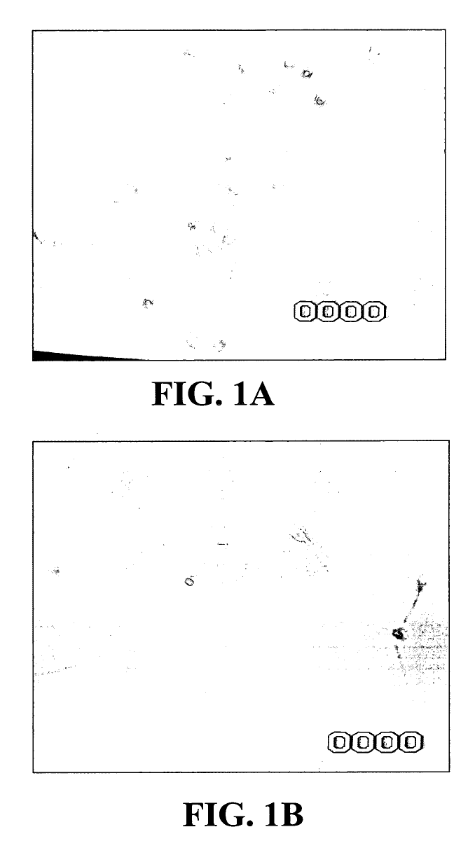

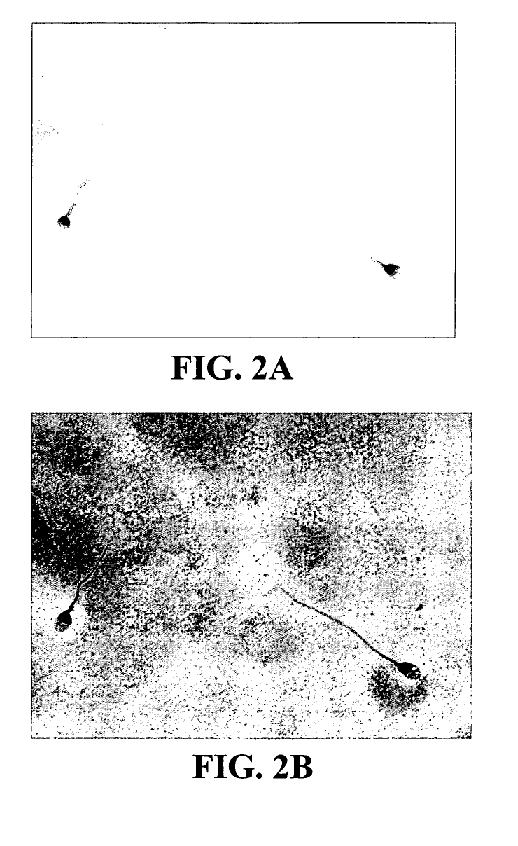

FIG. 1A is a photograph of air-dried sperm. It should be noted that the sperm morphology remains intact, excepting for kinked tails.

FIG. 1B is a photograph of air-dried and re-suspended sperm. The sperm have returned to normal morphology.

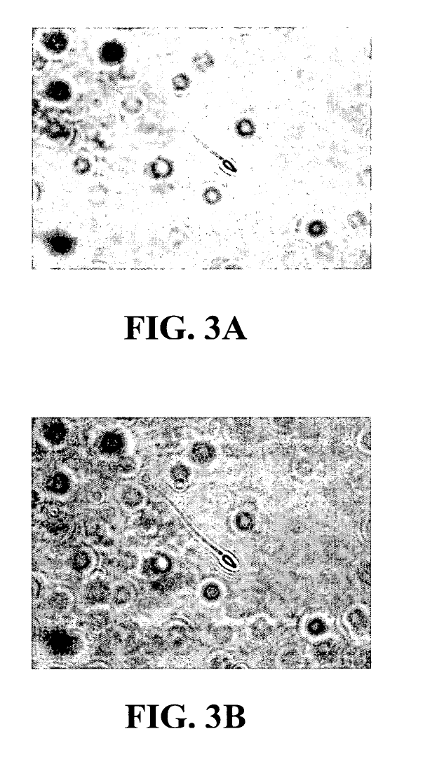

FIGS. 2A and 2B are photographs of the same air-dried sperm samples, after storage for 8-10 months at 0-8° C., under different lighting conditions. The sperm have kinked tails with no apparent breakage, which is similar to the appearance of sperm after short term storage (10 weeks). There is minimal ferning (crystal formation) as compared to the extensive ferning seen in ambient conditions. The sperm retain normal morphology similar to sperm after short term storage.

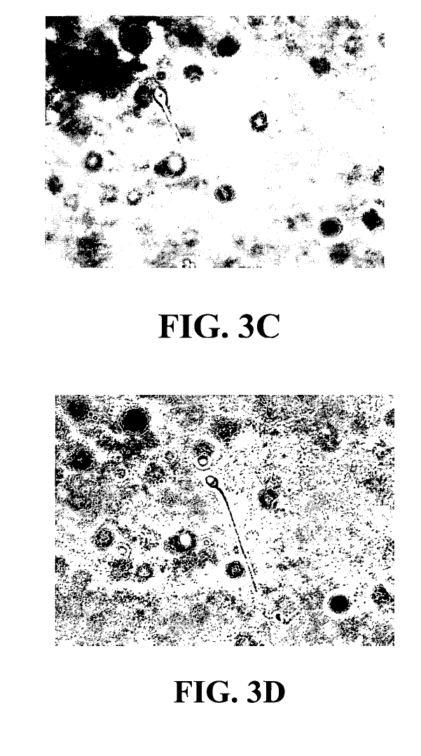

FIGS. 3A, 3B, 3C, and 3D are photographs of re-suspended sperm after air-drying and storage for 8-10 months at 0° C. FIGS. 3A and 3B are photographs of the same sperm under different light conditions. FIGS. 3C and 3D are photographs of the same sperm under different light conditions. The normal sperm architecture is restored even after prolonged storage.

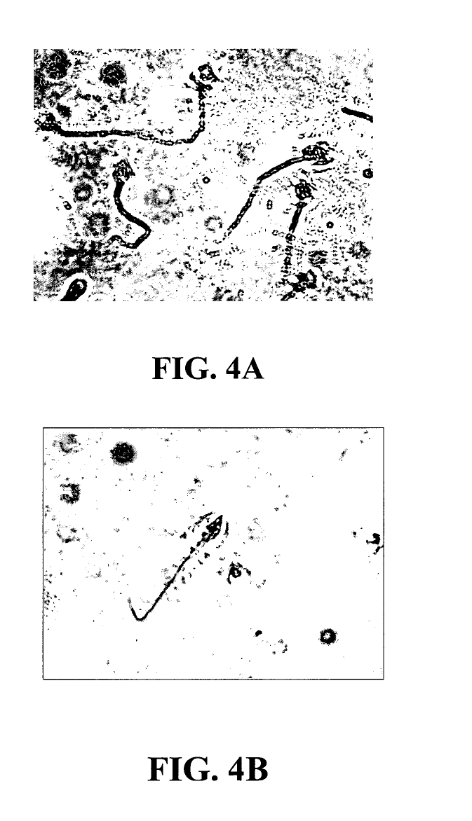

FIGS. 4A and 4B are photographs of an air-dried sperm after storage for 6-8 months at ambient temperature, before resuspension. There is a significant amount of ferning, due to crystal formation as the result of excessive dehydration. The sperm architecture is disorganised with apparent fragmentation of the sperm head and fractures of the sperm tail

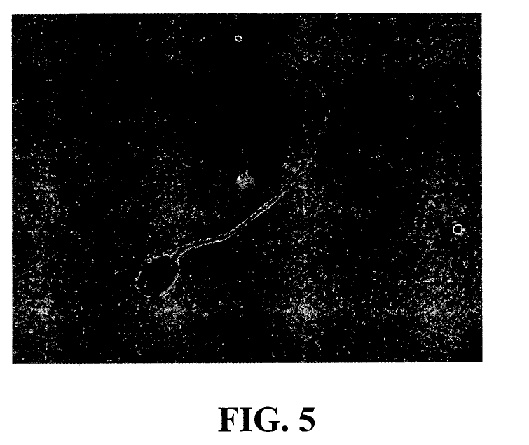

FIG. 5 is a photograph of an air-dried sperm, re-suspended after prolonged storage at ambient temperature. The sperm has an enlarged head and there is loss of a normal sperm head architecture. There are also halos of sperm heads without tails in the background.

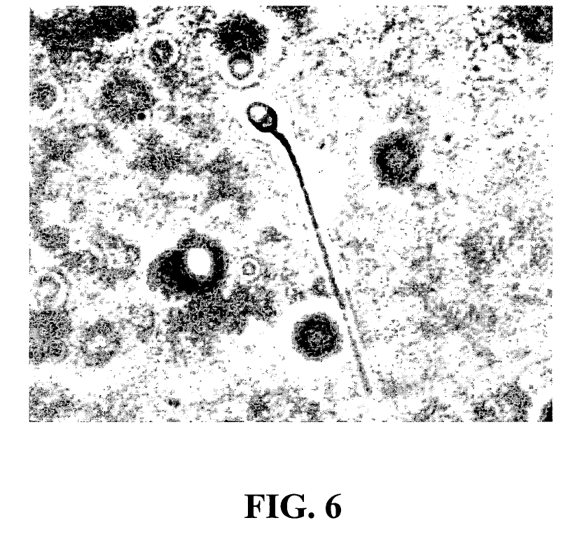

FIG. 6 is a photograph of an air-dried sperm after storage for 9 months at 8° C., before re-suspension. The normal sperm head architecture is retained, but there is the appearance of fractures in the sperm tail. There is also fine ferning on the slide indicating increasing desiccation

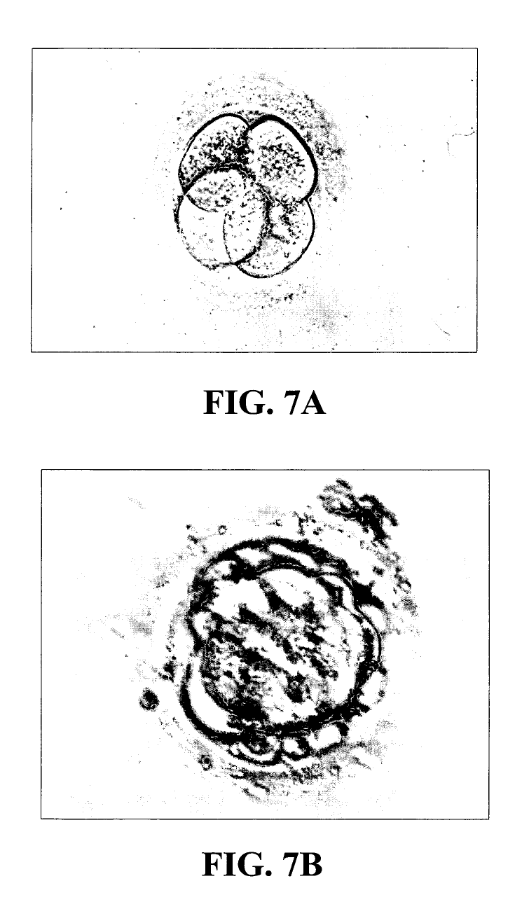

FIGS. 7A and 7B are photographs of human embryos derived from eggs fertilised by air-dried sperm. FIG. 7A is a photograph of a normal, 4-cell human embryo. FIG. 7B is a photograph of an early human blastocyst.

### EXAMPLE

Semen samples were obtained from men whose wives were undergoing ovarian stimulation for ICSI treatment for male factor infertility 48 hours prior to oocyte recovery. Pure sperm pellets from standard sperm recovery techniques were spread on pre-washed, hot air dried and sterilised glass slides and the samples were allowed to dry in open air in a laminar flow chamber. The slides were stored in a sterile semen collection container at 8° C. until required for ICSI.

Following the recovery and denudation of oocytes, all of the metaphase II oocytes were selected for treatment using sperm from fresh semen samples. These samples comprised the therapeutic group. All the metaphase I oocytes were cultured for up to 24 hours and then inspected for first polar body extrusion, indicating metaphase II prior to ICSI using re-suspended air dried sperm that had been in storage. These samples made up the experimental group. The injected oocytes were cultured under standard conditions and a comparison made between the therapeutic (eggs that had been injected with sperm from fresh semen samples from the same male) and experimental groups for pronuclei formation and normal embryonic cleavage.

Results

Of the 38 metaphase I oocytes, 24 extruded first polar bodies and were subjected to ICSI with re-suspended air dried sperm. Twenty-two of 24 (91.7%) demonstrated 2 pronuclei and second polar body extrusion 18 hours later, comparable to 97 of 108 (89.8%) in the therapeutic group. At 48 hours post ICSI, 11 of 22 (50%) and 8 of 22 (36.4%) of the two pronuclei experimental oocytes were at 2 and 4 cells respectively. This is also comparable to the 54 of 97 (55.7%) and the 38 of 97 (32.9%) in the therapeutic group.

At 72 hours post ICSI, the therapeutic group had a significantly higher number of 8 or more cell embryos: 49 of 97 (50.5%) versus 4 of 22 (18.2%); p<0.005; and fewer two cell embryos 14 of 97 (14.4%) versus 10 of 22 (45.4%); p<0.005, as compared to the experimental group. Two embryos in the experimental group developed to expanded blastocysts. These results are summarized in Table 1, Table 2 and Table 3.

These results indicate that human spermatozoa can be preserved by simply air drying a semen sample. They can be recovered intact after prolonged storage at 0° C.-8° C. These spermatozoa are capable of successfully participating in the process of fertilization even after prolonged storage. In particular, their ability to participate in pronuclei formation and the development of cleavage stage embryos is not impaired. As oocytes fertilized with recovered air dried sperm can develop to the blastocyst stage, the process of air drying does not cause such damage as to prevent early pre-implantation development of embryos.

TABLE 1
Outcome of ICSI with Fresh and Air-Dried Sperm

| | No. of oocytes | No. of oocytes |
|---|---|---|
| Type of sperm | injected | fertilized |
| Fresh | 108 | 97 (89.8%) |
| Air-Dried | 24 | 22 (86.4%) |
| | (matured from 38MI) | |

No significant difference in fertilization rate.

TABLE 2
Cleavage Patterns of Fresh and Air-Dried Sperm Derived Embryos:
Day 2 Post-ICSI.

| Type of | Total | Total Cleaved | 2-cells | 3-4 cells |
|---|---|---|---|---|
| Sperm | Fertilized | (%) | (%) | (%) |
| Fresh | 97 | 92 (94.8) | 54 (55.7) | 38 (39.2) |
| Air-Dried | 22 | 19 (86.4) | 11 (50) | 8 (36.4) |

No significant difference in cleavage rate.

TABLE 3
Cleavage Patterns of Fresh and Air-Dried Sperm Derived Embryos:
Day 3 Post-ICSI.

| | | Total | | | |
|---|---|---|---|---|---|
| Type of | Total | Cleaved | 2-cells | 4-cells | 8-cells |
| Sperm | Fertilized | (%) | (%) | (%) | (%) |
| Fresh | 97 | 92 | 14** | 29 | 49** |
| | | (94.8) | (14.4) | (30) | (50.5) |
| Air-Dried | 22 | 19 | 10 | 5 | 4 |
| | | (86.4) | (45.4) | (22.7) | (18.2) |

Significant difference in developmental pattern **p < 0.005.
Possibly due to the quality of eggs (in vitro matured) used in the studies.

1. A method for preserving a semen sample comprising:
a) receiving a semen sample, and
b) allowing said sample to air dry.

2. The method of claim 1 wherein the method further comprises spreading the sample onto a sterile plate prior to drying.

3. The method of claim 1 wherein the method further comprises liquefying the sample prior to drying.

4. The method of claim 1 wherein the method further comprises separating spermatozoa from contaminants in the semen sample.

5. The method of claim 4 wherein the sample is separated by centrifuging the semen sample to concentrate the spermatozoa.

6. The method of claim 4 wherein the sample is separated by layering the semen sample onto a two layer discontinuous percoll layer followed by centrifugation.

7. The method of claim 1 wherein the method further comprises storing the air dried sample at 0° C. to 8° C.

8. A method of claim 1 wherein the method further comprises recovering the air dried sample by adding a warm physiological solution to the sample.

9. A method for preserving a semen sample comprising:
a) allowing a semen sample to air dry, and
b) recovering the sample by adding a warm physiological solution to the sample.

10. The method of claim 9 wherein the method further comprises spreading the sample onto a sterile plate prior to drying.

11. The method of claim 9 wherein the method further comprises liquefying the sample prior to drying.

12. The method of claim 9 wherein the method further comprises separating spermatozoa from contaminants in the semen sample.

13. The method of claim 12 wherein the sample is separated by centrifuging the semen sample to concentrate the spermatozoa.

14. The method of claim 12 wherein the sample is separated by layering the semen sample onto a two layer discontinuous percoll layer followed by centrifugation.

15. The method of claim 9 wherein the method further comprises storing the air dried sample at 0° C. to 8° C.

16. The method of claim 9 wherein the recovered sample is used for in vitro fertilisation.

17. The method of claim 9 wherein the recovered sample is used for intracystoplasmic sperm injection (ICSI).
